(19) United States
(12) Patent Application Publication
(10) Pub. No.: US 2026/0268839 A1
(43) Pub. Date: Sep. 10, 2026

(54) DISPLAY DEVICE AND ELECTRONIC DEVICE USING THE SAME

(71) Applicant: Samsung Display Co., Ltd., Yongin-Si (KR)

(72) Inventors: Min Woo KIM, Yongin-si (KR); Deok Ho KANG, Yongin-si (KR)

(21) Appl. No.: 19/535,913

(22) Filed: Feb. 10, 2026

(30) Foreign Application Priority Data
Mar. 5, 2025 (KR) 10-2025-0028365
Jun. 11, 2025 (KR) 10-2025-0076421

(51) Int. Cl. G09G 3/3208

(52) U.S. Cl. CPC G09G 3/3208; G09G 2330/02

(57) ABSTRACT

According to an embodiment, a display device comprises a display panel configured to display an image in an image display area, a main driving circuit configured to control an image display operation of the display panel, and a power supply circuit mounted on a circuit board and configured to supply a direct current (DC) driving voltage to the main driving circuit. The circuit board includes: a main voltage wiring configured to transmit a DC driving voltage of a first level, output from the power supply circuit, to a first power input terminal of the main driving circuit; and a first sub-voltage wiring branched from the main voltage wiring and configured to transmit a DC driving voltage of a second level, which is lower than the first level, to a second power input terminal of the main driving circuit.

### CROSS-REFERENCE TO RELATED APPLICATION

This application claims priority from Korean Patent Application No. 10-2025-0028365 filed on Mar. 5, 2025 and No. 10-2025-0076421 filed on Jun. 11, 2025 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a display device and an electronic device including using the same.

### 2. Description of the Related Art

As the information society develops, the demand for display devices for displaying images is increasing in various forms. For example, display devices are being applied to various electronic devices such as smartphones, digital cameras, laptop computers, navigation systems, and smart televisions.

The display devices may be flat panel display devices such as a liquid crystal display (LCD) device or an organic light-emitting diode (OLED) display device. Among these flat panel display devices, the OLED display device includes a light-emitting element capable of self-emission in each pixel of the display panel, and thus can display an image without a backlight unit that supplies light to the display panel. In addition, the OLED display device may display an image in a transparent or semi-transparent state through a manufacturing method that uses a transparent substrate or forms light-transmitting holes.

Meanwhile, recently, in using display devices, securing mobility has become an important issue for the users. In particular, various mobile display devices having performance comparable not only to mobile phones but also to tablet PCs, laptops, and desktops are being sold.

### SUMMARY

The present disclosure may provide a display device and an electronic device including the same, capable of stabilizing variation ranges of driving voltages by improving the branching positions and structures of driving voltage wirings patterned on a circuit board of the display device.

The present disclosure may provide a display device and an electronic device including the same, capable of stably narrowing the variation range of direct current (DC) driving voltages by improving the design structure such that the wiring resistances of sub-voltage wirings branched from a main high-power voltage wiring differ from one another.

Aspects of the present disclosure are not limited to those mentioned above, and other aspects not explicitly stated will be clearly understood by those skilled in the art based on the following description.

According to an embodiment of the present disclosure, a display device comprises a display panel configured to display an image in an image display area, a main driving circuit configured to control an image display operation of the display panel, and a power supply circuit mounted on a circuit board and configured to supply a direct current (DC) driving voltage to the main driving circuit, wherein the circuit board includes: a main voltage wiring configured to transmit a DC driving voltage of a first level, output from the power supply circuit, to a first power input terminal of the main driving circuit; and a first sub-voltage wiring branched from the main voltage wiring and configured to transmit a DC driving voltage of a second level, which is lower than the first level, to a second power input terminal of the main driving circuit.

According to an embodiment of the present disclosure, an electronic device comprises a display device configured to display an image, an image signal processor configured to control an image display timing of the display device, and a power supply module configured to provide a power signal to the display device, wherein the display device includes: a display panel configured to display an image in an image display area; a main driving circuit configured to control an image display operation of the display panel; and a power supply circuit mounted on a circuit board and configured to supply a direct current (DC) driving voltage to the main driving circuit, and the circuit board includes: a main voltage wiring configured to transmit a DC driving voltage of a first level, output from the power supply circuit, to a first power input terminal of the main driving circuit; and a first sub-voltage wiring branched from the main voltage wiring and configured to transmit a DC driving voltage of a second level, which is lower than the first level, to a second power input terminal of the main driving circuit.

According to the display device and the electronic device of the present disclosure, it is possible to stabilize the variation range of driving voltages by improving the branching positions and structures of driving voltage wirings patterned on a circuit board of the display device or the like.

According to the display device and the electronic device including the same of the present disclosure, it is also possible to stably narrow the variation range of DC driving voltages by improving the design structure such that the wiring resistances of sub-voltage wirings branched from a main voltage wiring differ from one another.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing embodiments thereof in detail with reference to the attached drawings, in which:

FIG. 1 is a plan view illustrating components of a display device according to an embodiment;

FIG. 2 is a cross-sectional view illustrating the components of the display device illustrated in FIG. 1;

FIG. 3 is a layout view illustrating an example of a display panel according to an embodiment;

FIG. 4 is a layout view illustrating an example of a touch sensing unit according to an embodiment;

FIG. 5 is a circuit diagram of a first embodiment for the arrangement of a main voltage wiring and a sub-voltage wiring on a circuit board illustrated in FIGS. 1 and 2;

FIG. 6 is a circuit diagram of a second embodiment for the arrangement of the main voltage wiring and the sub-voltage wiring on the circuit board illustrated in FIGS. 1 and 2;

FIG. 7 is a circuit diagram of a third embodiment for the arrangement of the main voltage wiring and the sub-voltage wiring on the circuit board illustrated in FIGS. 1 and 2;

FIG. 8 is a circuit diagram of a fourth embodiment for the arrangement of the main voltage wiring and the sub-voltage wiring on the circuit board illustrated in FIGS. 1 and 2;

FIG. 9 is a block diagram of an electronic device including a display device according to an embodiment; and

FIG. 10 illustrates a set of schematic views of electronic devices according to various embodiments.

### DETAILED DESCRIPTION

The present disclosure will now be described more fully hereinafter with reference to the accompanying drawings, in which preferred embodiments of the disclosure are shown. This disclosure may, however, be embodied in different forms and should not be construed as limited to the embodiments set forth herein. Rather, these embodiments are provided so that this disclosure will be thorough and complete, and will filly convey the scope of the disclosure to those skilled in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Specific embodiments will hereinafter be described with reference to the accompanying drawings.

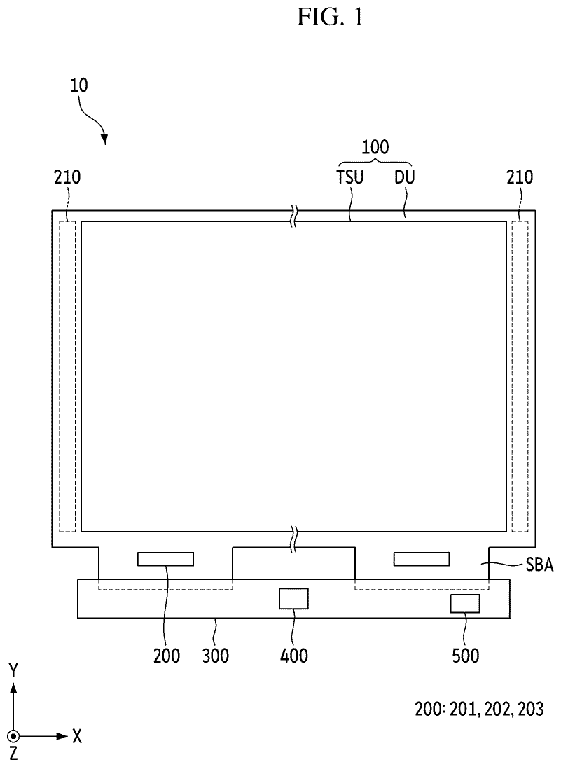

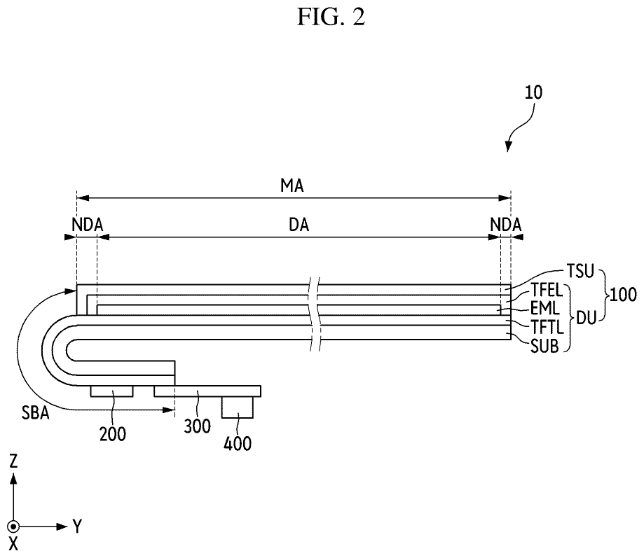

FIG. 1 is a plan view illustrating components of a display device according to an embodiment. FIG. 2 is a cross-sectional view illustrating the components of the display device illustrated in FIG. 1.

Referring to FIGS. 1 and 2, a display device 10 according to an embodiment may be classified in various manners depending on its display scheme. For example, the display device 10 may be classified and configured as an organic light-emitting diode (OLED) display device, an inorganic electroluminescent (inorganic EL) display device, a quantum dot electroluminescent (QED) display device, a micro light-emitting diode (micro-LED) display device, a nano light-emitting diode (nano-LED) display device, a plasma display panel (PDP), a field emission display (FED), a liquid crystal display (LCD) device, or an electrophoretic display (EPD). The OLED display device will hereinafter be described as an example of the display device 10, and will hereinafter be referred to as the display device 10. However, the display device 10 is not limited to the OLED display device and may also be implemented using various other types of display devices listed above or known in the art, within the technical idea of the present disclosure.

As illustrated in FIGS. 1 and 2, a display panel 100 of the display device 10 includes an image display unit DU, a plurality of data driving circuits 200, a circuit board 300, a main driving circuit 400, a power supply circuit 500, and a touch sensing module.

The touch sensing module may include a touch sensing unit TSU positioned on the front surface of the display panel 100 and one or more touch driving circuits generating touch coordinate data of the touch sensing unit TSU. Here, the touch driving circuits may be integrally formed with the main driving circuit 400, in which case, the main driving circuit 400 may generate the touch coordinate data of the touch sensing unit TSU.

The display unit DU of the display panel 100 includes a plurality of pixels, and images may be displayed through the pixels. Each of the pixels may include red, green, and blue subpixels, or red, green, blue, and white subpixels.

The image display unit DU receives data signals (e.g., analog data voltages) from the data driving circuits 200 and receives gate signals from the main driving circuit 400. In response to the data signals and gate signals, images may be displayed through a plurality of subpixels SP arranged in an image display area DA of the image display unit DU.

Meanwhile, the display panel 100 may be divided into a main area MA and a sub-area SBA. The main area MA may include a display area DA, a folding area, and a non-display area NDA. Images may be displayed through the pixels in the display area DA and the folding area.

The sub-area SBA may extend from one side of the main area MA. The sub-area SBA may include a flexible material capable of bending, folding, or rolling. For example, when bent, the sub-area SBA may overlap the main area MA in a thickness direction (e.g., a Z-axis direction). The sub-area SBA may include a pad unit connected to the main driving circuit 400 and the circuit board 300. Optionally, the sub-area SBA may be omitted, and the main driving circuit 400 and the pad unit may be arranged in the non-display area NDA.

The circuit board 300 may be attached to the pad unit of the display panel 100 using an anisotropic conductive film (ACF). Lead wirings of the circuit board 300 may be electrically connected to the pad unit of the display panel 100. The circuit board 300 may be a flexible film such as a flexible printed circuit board (FPCB), a printed circuit board (PCB), or a chip on film (COF).

Meanwhile, a substrate SUB of the display panel 100 illustrated in FIG. 2 may be a base substrate or a base member. The substrate SUB may be flat. Alternatively, the substrate SUB may be a flexible substrate capable of bending, folding, or rolling. In one example, the substrate SUB may include a glass material or a metal material, but is not limited thereto. In another example, the substrate SUB may include a polymer resin such as polyimide (PI).

A thin-film transistor layer TFTL may be positioned on the substrate SUB. The thin-film transistor layer TFTL may include a plurality of thin-film transistors that form pixel circuits of the respective pixels. The thin-film transistor layer TFTL may further include gate wirings, data wirings, power wirings, gate control wirings, fan-out wirings connecting the data driving circuits 200 to the data wirings, and lead wirings connecting the data driving circuits 200 to the pad unit. When gate drivers 210 are formed on respective sides of the non-display area NDA of the display panel 100, each gate driver 210 may also include thin-film transistors.

The thin-film transistor layer TFTL may be selectively arranged in the image display area DA, the non-display area NDA, and the sub-area SBA. The thin-film transistors, gate wirings, data wirings, and power wirings of the thin-film transistor layer TFTL may be arranged in the image display area DA. The gate control wirings and fan-out wirings of the thin-film transistor layer TFTL may be arranged in the non-display area NDA. The lead wirings of the thin-film transistor layer TFTL may be arranged in the sub-area SBA.

A light-emitting element layer EML may be arranged on the thin-film transistor layer TFTL. The light-emitting element layer EML may include a plurality of light-emitting elements in which first electrodes, emission layers, and second electrodes are sequentially stacked to emit light, and may further include a pixel defining layer that defines individual pixels. The light-emitting elements of the light-emitting element layer EML may be arranged across the entire display area DA.

An encapsulation layer TFEL may cover the upper surface and side surfaces of the light-emitting element layer EML and protect the light-emitting element layer EML. The encapsulation layer TFEL may include at least one inorganic layer and at least one organic layer for encapsulating the light-emitting element layer EML.

The touch sensing unit TSU may be disposed on the encapsulation layer TFEL of the display panel 100. The touch sensing area of the touch sensing unit TSU may include a plurality of touch electrodes for sensing a user's touch through a capacitive method, and touch driving wirings that connect the touch electrodes to the touch driving circuits or the main driving circuit 400. In each touch sensing area, the touch electrodes may be arranged in a matrix form, enabling the user's touch to be sensed using a self-capacitance or mutual capacitance method.

The touch sensing unit TSU may not be integrally formed in the display panel 100 but may instead be arranged on a separate substrate or film on the display unit DU of the display panel 100. In this case, the substrate or film supporting the touch sensing unit TSU may be a base member that encapsulates the display unit DU.

The main driving circuit 400 may be formed in the form of an integrated circuit (IC) and may be mounted in the non-display area NDA or the sub-area SBA of the display panel 100 or on the circuit board 300 by a chip-on-glass (COG), chip-on-plastic (COP), or ultrasonic bonding method. The main driving circuit 400 operates as a main processor and outputs digital image data and gate and data control signals for driving the pixels of the image display unit DU. Specifically, the main driving circuit 400 sequentially arranges digital image data input from an external graphics card or graphics system in units of at least one frame according to the resolution and driving frequency of the display panel 100. The main driving circuit 400 transmits the sequentially arranged digital image data to the data driving circuits 200 in units of at least one horizontal line, and sends data control signals to the data driving circuits 200 and gate control signals to the gate drivers 210.

The main driving circuit 400 may be configured as an IC structure including the touch driving circuits, and may generate touch coordinate data for the touch sensing area. For example, by including the touch driving circuits, the main driving circuit 400 may supply touch driving signals to the touch electrodes arranged in a matrix in the touch sensing unit TSU and sense changes in capacitance between the touch electrodes. Based on the changes in capacitance, the main driving circuit 400 may identify the user's touch input and calculate the touch coordinate data.

The data driving circuits 200 may be formed as ICs and may be disposed on each printed circuit film using a COG, COP, or ultrasonic bonding method. The data driving circuits 200 convert digital image data into analog data signals according to the data control signals from the main driving circuit 400 and supply the data signals to the respective pixels. Here, the data driving circuits 200 may supply the data signals to data wirings connected to the pixels.

The power supply circuit 500 may be formed as an IC and may be mounted on the circuit board 300 using a COG, COP, or ultrasonic bonding method.

The power supply circuit 500 converts an external supply voltage into gate driving voltages of predetermined high and low potentials and supplies the gate driving voltages to the gate drivers 210 through gate power wirings.

The power supply circuit 500 also converts the external supply voltage into alternating current (AC) and direct current (DC) driving voltages of predetermined levels and selectively supplies the AC and DC driving voltages to the main driving circuit 400 and the data driving circuits 200. For example, the power supply circuit 500 may convert the external supply voltage into a DC driving voltage of a first level and supply the DC driving voltage of the first level to the main driving circuit 400 and the data driving circuits 200 through a main voltage wiring.

The circuit board 300 includes gate power wirings that transmit high and low gate driving voltages output from the power supply circuit 500 to the ACF or the sub-area SBA of the display panel 100. Specifically, gate power wirings are patterned or embedded between the gate driving voltage input terminals of the power supply circuit 500 and the connection terminals of the display panel 100.

The circuit board 300 also includes a main voltage wiring that transmits the DC driving voltage of the first level output from the power supply circuit 500 to a first power input terminal of the main driving circuit 400. The circuit board 300 further includes a first sub-voltage wiring branched from the main voltage wiring, which transmits a DC driving voltage of a second level lower than the first level to a second power input terminal of the main driving circuit 400.

Additionally, the circuit board 300 may further include a second sub-voltage wiring branched from the first sub-voltage wiring, which transmits a DC driving voltage of a third level lower than the second level to a third power input terminal of the main driving circuit 400.

The main voltage wiring and the first and second sub-voltage wirings may be patterned, printed, or embedded on the circuit board 300 by a photolithographic process or similar means.

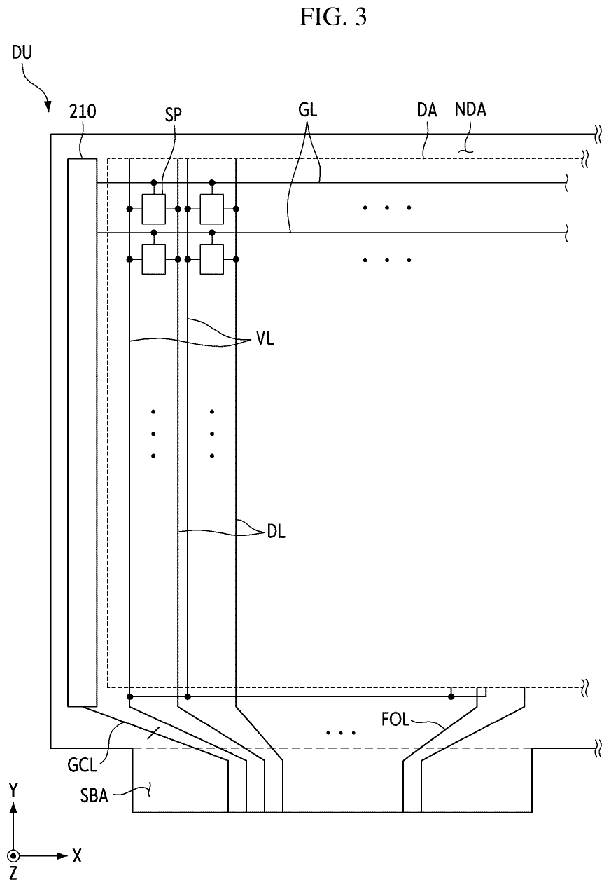

FIG. 3 is a layout view illustrating an example of a display panel according to an embodiment. Specifically, FIG. 3 is a layout view illustrating parts of the image display area DA and non-display area NDA of the display unit DU, prior to the formation of the touch sensing unit TSU.

The image display area DA may be defined as a central region including the central portion of the display panel 100. In one example, the display area DA may include a plurality of pixels SP, a plurality of gate lines GL, a plurality of data lines DL, and a plurality of power lines VL. Each of the pixels SP may be defined as a minimum unit for outputting light of a color such as red, green, blue, or white.

The gate lines GL may supply gate signals received from at least one gate driver 210 to the pixels SP. The gate lines GL may extend in a first direction (e.g., an X-axis direction) and may be spaced apart from one another in a second direction (e.g., a Y-axis direction) intersecting the first direction.

The data lines DL may supply data voltages received from the data driving circuit 200 to the pixels SP. The data lines DL may extend in the second direction and may be spaced apart from one another in the first direction.

The power lines VL may supply a power voltage applied from the main driving circuit 400 or a separate power supply circuit 500 to the pixels SP. Here, the power voltage may be at least one of a driving voltage, an initialization voltage, and a reference voltage. The power lines VL may extend in the second direction and may be spaced apart from one another in the first direction.

The non-display area NDA may be a peripheral region surrounding the display area DA and may ultimately be defined as a bezel area. The non-display area NDA may include the gate driver 210, fan-out lines FOL, and gate control lines GCL. The gate driver 210 may generate a plurality of gate signals based on gate control signals and may sequentially supply the gate signals to the gate lines GL in a predetermined order.

The fan-out lines FOL may extend from a data driving circuit 200 to the respective image display areas DA. The fan-out lines FOL may supply data voltages received from the data driving circuit 200 to the plurality of data lines DL.

The gate control line GCL may extend from the main driving circuit 400 to the gate driver 210. The gate control line GCL may supply gate control signals received from the main driving circuit 400 to the gate driver 210.

The data driving circuit 200 may supply data voltages to the data lines DL through the fan-out lines FOL. The data voltages may be supplied to the pixels SP and may determine the luminance of each of the pixels SP. In contrast, the main driving circuit 400 may supply gate control signals to the gate driver 210 through the gate control lines GCL, thereby controlling the driving timing of the gate driver 210, that is, the scan timing of the gate control lines GCL.

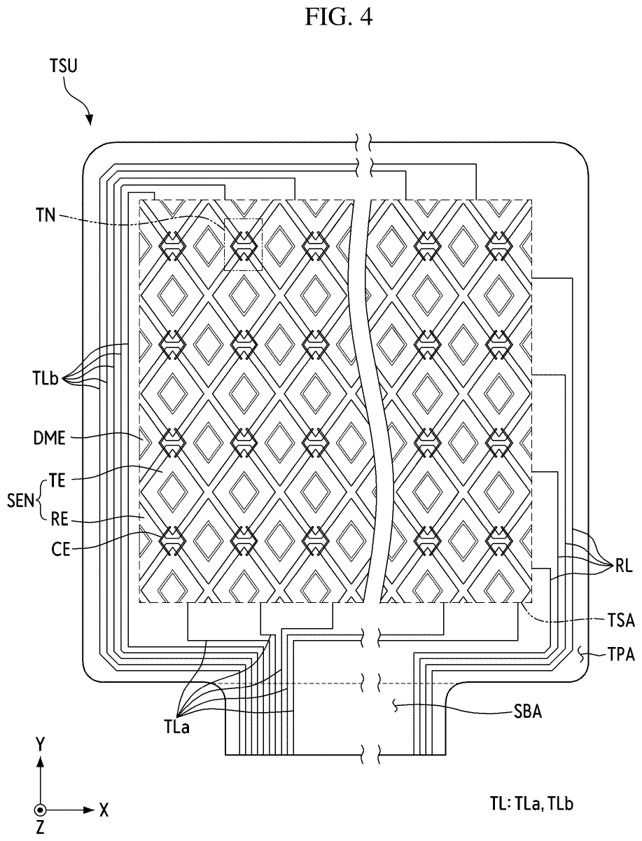

FIG. 4 is a layout view illustrating an example of a touch sensing unit according to an embodiment. Specifically, FIG. 4 is a layout view illustrating a planar structure of a touch sensing area TSA corresponding to the image display area DA.

Referring to FIG. 4, the touch sensing unit TSU may include a touch sensing area TSA that senses a user's touch, and a touch peripheral area TPA defined as a peripheral region of the touch sensing area TSA.

The touch sensing area TSA may overlap the image display area DA and the non-display area NDA of the display unit DU, thereby covering both the image display area DA and the non-display area NDA. Since the non-display area NDA is a bezel area, outer regions of the touch sensing area TSA that overlap and correspond to the non-display area NDA also correspond to the bezel area.

The touch peripheral area TPA corresponds to a region in which the gate driver 210 is arranged. Accordingly, the touch sensing area TSA may extend across and overlap the non-display area NDA excluding the region in which the gate driver 210 is arranged.

The touch sensing area TSA may include a plurality of touch electrodes SEN and a plurality of dummy electrodes DME. The touch electrodes SEN may form mutual capacitance or self-capacitance to detect a touch by an object or a person. The touch electrodes SEN may include a plurality of driving electrodes TE and a plurality of sensing electrodes RE.

The driving electrodes TE may be arranged in the X- and Y-axis directions. The driving electrodes TE may be spaced apart from one another in the X- and Y-axis directions. Adjacent driving electrodes TE in the Y-axis direction may be electrically connected to each other through multiple connection electrodes CE.

The driving electrodes TE may be connected to first touch pads (not illustrated) through driving lines TL. The driving lines TL may include lower driving lines TLa and upper driving lines TLb. For example, some of the driving electrodes TE arranged in a lower part of the touch sensing area TSA may be connected to the first touch pads through the lower driving lines TLa, and other driving electrodes TE arranged in an upper part of the touch sensing area TSA may be connected to the first touch pads through the upper driving lines TLb. The lower driving lines TLa may extend to the first touch pads along a lower part of the touch peripheral area TPA. The upper driving lines TLb may extend to the first touch pads via upper, left, and lower parts of the touch peripheral area TPA. Here, the first touch pads may be pads formed on the circuit board 300 and connected to at least one main driving circuit 400.

Adjacent driving electrodes TE in the Y-axis direction may be electrically connected through multiple connection electrodes CE, and even if one of the connection electrodes CE is disconnected, the driving electrodes TE may remain stably connected through the remaining connection electrodes CE. Two connection electrodes CE may connect adjacent driving electrodes TE, but the number of connection electrodes CE is not limited thereto. The connection electrodes CE may be bent at least once. For example, the connection electrodes CE may have a chevron shape (“<” or “>”), but the planar shape of the connection electrode CE is not limited thereto.

The connection electrodes CE may be positioned in a different layer from the driving electrodes TE and the sensing electrodes RE. Adjacent driving electrodes TE in the Y-axis direction may be electrically connected through the connection electrodes CE formed in a different layer from the driving electrodes TE or the sensing electrodes RE. The connection electrodes CE may be formed in a rear layer (or lower layer) relative to the layer where the driving electrodes TE and the sensing electrodes RE are formed. The connection electrodes CE may be electrically connected to the respective adjacent driving electrodes TE through a plurality of contact holes. Accordingly, even when the connection electrodes CE overlap the sensing electrodes RE in the Z-axis direction, the driving electrodes TE and the sensing electrodes RE may be insulated from each other. Mutual capacitance may be formed between the driving electrodes TE and the sensing electrodes RE.

Adjacent sensing electrodes RE in the X-axis direction may be electrically connected through connectors formed in the same layer as the driving electrodes TE or the sensing electrodes RE. That is, the plurality of sensing electrodes RE may extend in the X-axis direction and may be spaced apart from one another in the Y-axis direction. The sensing electrodes RE may be arranged in the X-and Y-axis directions, and adjacent sensing electrodes RE in the X-axis direction may be electrically connected through the connectors.

Touch nodes TN may be formed in regions where the connection electrodes CE that connect the driving electrodes TE and the connectors of the sensing electrodes RE intersect, and may be arranged in a matrix form in the touch sensing area TSA.

The sensing electrodes RE may be connected to second touch pads through sensing lines RL. For example, some of the sensing electrodes RE arranged in a right part of the touch sensing area TSA may be connected to the second touch pads through the sensing lines RL. The sensing lines RL may extend to the second touch pads via the right and lower parts of the touch peripheral area TPA. The second touch pads may be connected to at least one main driving circuit 400 through the circuit board 300.

The dummy electrodes DME may each be surrounded by the driving electrodes TE or the sensing electrodes RE. The dummy electrodes DME may be spaced apart and insulated from the driving electrodes TE or the sensing electrodes RE. Accordingly, the dummy electrodes DME may be electrically floated.

The main driving circuit 400 supplies touch driving signals to the driving electrodes TE. The main driving circuit 400 receives, as touch sensing signals of the driving electrodes TE, feedback signals respectively fed back from the driving electrodes TE, and also receives touch sensing signals for the sensing electrodes RE from the sensing electrodes RE. Accordingly, the main driving circuit 400 measures changes in magnitude of the touch sensing signals received from the driving electrodes TE and sensing electrodes RE and measures charge variations in mutual capacitance at the touch nodes TN formed by the driving electrodes TE and sensing electrodes RE. The main driving circuit 400 may determine the user's touch position and touch movement direction based on the charge variations in mutual capacitance at the touch nodes TN. In this manner, the main driving circuit 400 determines whether there is touch input from the user's body part, such as a finger, or a touch input device, and calculates the touch coordinates for each touch sensing area TSA, based on changes in capacitance between the touch electrodes.

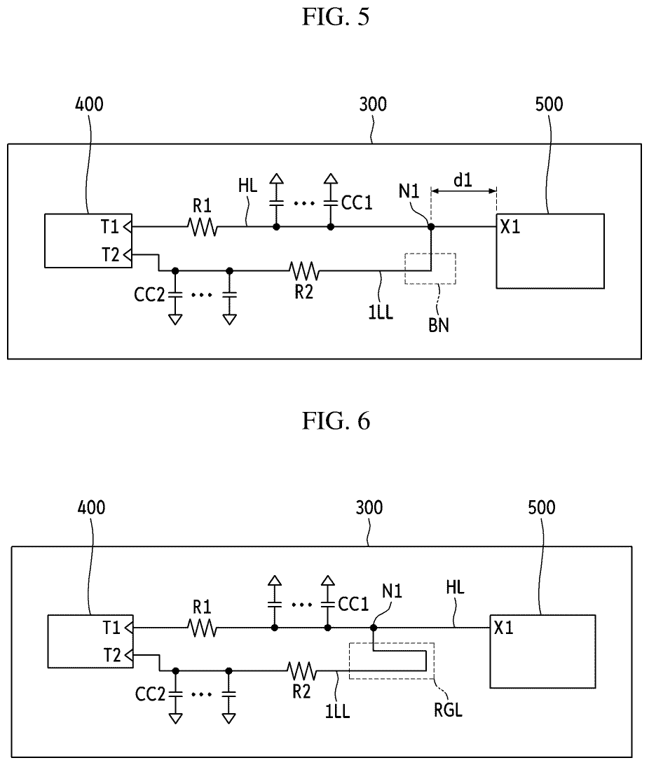

FIG. 5 is a circuit diagram of a first embodiment of the arrangement of a main voltage wiring and a sub-voltage wiring on the circuit board illustrated in FIGS. 1 and 2.

Referring to FIG. 5, the circuit board 300 includes a main voltage wiring HL that transmits a DC driving voltage of a first level, output from a first driving voltage output terminal X1 of the power supply circuit 500, to a first power input terminal T1 of the main driving circuit 400. The circuit board 300 further includes a first sub-voltage wiring 1LL branched from the main voltage wiring HL to transmit a DC driving voltage of a second level, which is lower than the first level, to a second power input terminal T2 of the main driving circuit 400.

The main voltage wiring HL includes a first wiring resistor R1 having a first resistance and at least one first capacitor CC1 having a first capacitance. The main voltage wiring HL may be connected and arranged in a straight-line form with the shortest distance and with no bends or curves between the first driving voltage output terminal X1 of the power supply circuit 500 and the first power input terminal T1 of the main driving circuit 400.

The first sub-voltage wiring 1LL branches from a first node N1 of the main voltage wiring HL and transmits a DC driving voltage of the second level, which is lower than the first level, to the second power input terminal T2 of the main driving circuit 400.

The first sub-voltage wiring 1LL branches from the first node N1 of the main voltage wiring HL, which is located at a position closer to the power supply circuit 500 than to the main driving circuit 400, i.e., at a position at a first distance d1 from the power supply circuit 500.

The first sub-voltage wiring 1LL includes a second wiring resistor R2 having a second resistance higher than the first resistance of the wiring resistor R1 and at least one second capacitor CC2 having a second capacitance.

The first sub-voltage wiring 1LL may be connected and arranged to include at least one bend BN between the branched first node N1 and the second power input terminal T2 of the main driving circuit 400.

The length of the first sub-voltage wiring 1LL branched from the first node N1 of the main voltage wiring HL may be formed to be greater than the length of the main voltage wiring HL. In addition, the width, thickness, height, or area of the first sub-voltage wiring 1LL branched from the first node N1 may be formed to be smaller than those of the main voltage wiring HL.

As described above, the first sub-voltage wiring 1LL has a second wiring resistor R2 with a higher resistance than the first wiring resistor R1 of the main voltage wiring HL and branches at a position of the first node N1 that is closer to the power supply circuit 500. Therefore, a DC driving voltage of the second level, which is lower than the DC driving voltage of the first level supplied to the first power input terminal T1 of the main driving circuit 400 through the main voltage wiring HL, is supplied to the second power input terminal T2 of the main driving circuit 400 through the first sub-voltage wiring 1LL.

As the DC driving voltage of the main voltage wiring HL is distributed through the first sub-voltage wiring 1LL having a higher resistance, the voltage variation range of the DC driving voltage applied to the main voltage wiring HL may be narrowed to within the first level.

FIG. 6 is a circuit diagram of a second embodiment of the arrangement of the main voltage wiring and the sub-voltage wiring on the circuit board illustrated in FIGS. 1 and 2.

Referring to FIG. 6, the main voltage wiring HL includes a first wiring resistor R1 having a first resistance and at least one first capacitor CC1, and may be connected and arranged in a straight-line form with the shortest distance and with no bends or curves between the first driving voltage output terminal X1 of the power supply circuit 500 and the first power input terminal T1 of the main driving circuit 400.

The first sub-voltage wiring 1LL branches from the first node N1 of the main voltage wiring HL and transmits a DC driving voltage of the second level, which is lower than the first level, to the second power input terminal T2 of the main driving circuit 400.

As illustrated in FIG. 6, the first sub-voltage wiring 1LL may be connected and arranged to include a wiring pattern portion RGL with at least one bent pattern formed between the first node N1 and the second power input terminal T2 of the main driving circuit 400.

The first sub-voltage wiring 1LL branches from the first node N1 and bends in a direction opposite to which the main voltage wiring HL extends from the power supply circuit 500. The first sub-voltage wiring 1LL may be bent in an angled-U shape or reversed angled-U shape, and may be electrically connected to the second power input terminal T2 of the main driving circuit 400.

As the first sub-voltage wiring 1LL includes an angled-U-shaped or reversed angled-U-shaped wiring pattern portion RGL, the first sub-voltage wiring 1LL may maintain the resistance of the second wiring resistor R2 higher than that of the first wiring resistor R1 of the main voltage wiring HL. Therefore, a DC driving voltage of the second level, which is lower than the DC driving voltage of the first level supplied to the first power input terminal T1 of the main driving circuit 400 through the main voltage wiring HL, is supplied to the second power input terminal T2 of the main driving circuit 400 through the first sub-voltage wiring 1LL.

The length of the first sub-voltage wiring 1LL branched from the first node N1 of the main voltage wiring HL may be formed to be greater than the length of the main voltage wiring HL. In addition, the width, thickness, height, or area of the first sub-voltage wiring 1LL branched from the first node N1 may be formed to be smaller than those of the main voltage wiring HL.

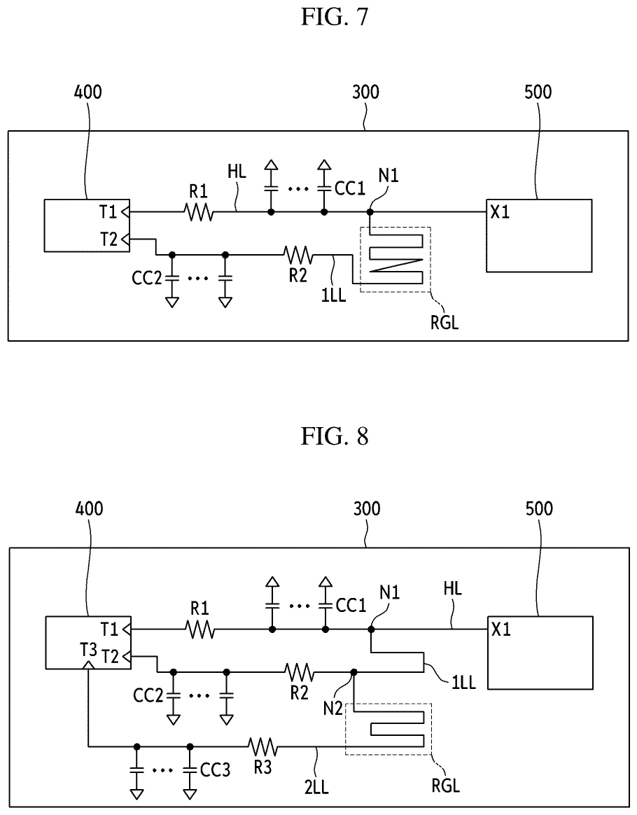

FIG. 7 is a circuit diagram of a third embodiment of the arrangement of the main voltage wiring and the sub-voltage wiring on the circuit board illustrated in FIGS. 1 and 2.

Referring to FIG. 7, the main voltage wiring HL includes a first wiring resistor R1 having a first resistance and at least one first capacitor CC1, and may be connected and arranged in a straight-line form with the shortest distance and with no bends or curves between the first driving voltage output terminal X1 of the power supply circuit 500 and the first power input terminal T1 of the main driving circuit 400.

In contrast, the first sub-voltage wiring 1LL branches from the first node N1 of the main voltage wiring HL and transmits a DC driving voltage of the second level, which is lower than the first level, to the second power input terminal T2 of the main driving circuit 400.

The first sub-voltage wiring 1LL includes a second wiring resistor R2 having a second resistance higher than the first resistance of the wiring resistor R1 and at least one second capacitor CC2. The first sub-voltage wiring 1LL may be connected and arranged to include a wiring pattern portion RGL with at least one bent pattern between the first node N1 and the second power input terminal T2 of the main driving circuit 400.

The first sub-voltage wiring 1LL branches from the first node N1 and bends in a direction opposite to which the main voltage wiring HL extends from the power supply circuit 500. The first sub-voltage wiring 1LL may be electrically connected to the second power input terminal T2 of the main driving circuit 400 by being bent in a shape obtained by combining and including at least one of an angled-U shape, a reversed angled-U shape, and a Z shape, at the wiring pattern portion RGL.

As the first sub-voltage wiring 1LL includes a wiring pattern portion RGL in the shape obtained by combining and including at least one of an angled-U shape, a reversed angled-U shape, and a Z shape, the first sub-voltage wiring 1LL may maintain the resistance of the second wiring resistor R2 higher than that of the first wiring resistor R1 of the main voltage wiring HL. Therefore, a DC driving voltage of the second level, which is lower than the DC driving voltage of the first level supplied to the first power input terminal T1 of the main driving circuit 400 through the main voltage wiring HL, is supplied to the second power input terminal T2 of the main driving circuit 400 through the first sub-voltage wiring 1LL.

FIG. 8 is a circuit diagram of a fourth embodiment illustrating the arrangement of the main voltage wiring and the sub-voltage wiring on the circuit board illustrated in FIGS. 1 and 2.

Referring to FIG. 8, the main voltage wiring HL includes a first wiring resistor R1 having a first resistance and at least one first capacitor CC1, and may be connected and arranged in a straight-line form with the shortest distance and with no bends or curves between the first driving voltage output terminal X1 of the power supply circuit 500 and the first power input terminal T1 of the main driving circuit 400.

The first sub-voltage wiring 1LL branches from the first node N1 of the main voltage wiring HL and transmits a DC driving voltage of the second level, which is lower than the first level, to the second power input terminal T2 of the main driving circuit 400. Specifically, the first sub-voltage wiring 1LL includes a second wiring resistor R2 having a second resistance higher than the first resistance of the wiring resistor R1 and at least one second capacitor CC2, and may be connected and arranged to include a wiring pattern portion RGL with at least one bent pattern formed between the first node N1 and the second power input terminal T2 of the main driving circuit 400.

In addition, the circuit board 300 may further include a second sub-voltage wiring 2LL branched from the first sub-voltage wiring 1LL to transmit a DC driving voltage of a third level, which is lower than the second level, to a third power input terminal T3 of the main driving circuit 400.

Specifically, the second sub-voltage wiring 2LL includes a third wiring resistor R3 having a third resistance higher than the second resistance of the wiring resistor R2 and at least one third capacitor CC3, and may be connected and arranged to include a wiring pattern portion RGL with at least one bent pattern formed between a second node N2 of the first sub-voltage wiring 1LL and the third power input terminal T3 of the main driving circuit 400.

A portion of the second sub-voltage wiring 2LL included in the wiring pattern portion RGL branches from the second node N2, bends in a direction opposite to the main voltage wiring HL and the first sub-voltage wiring 1LL, i.e., in the direction in which the power supply circuit 500 is arranged, and may be electrically connected to the third power input terminal T3 of the main driving circuit 400 by being bent in an angled-U shape or a reversed angled-U shape.

The length of the second sub-voltage wiring 2LL branched from the second node N2 of the first sub-voltage wiring 1LL may be formed to be greater than the length of the first sub-voltage wiring 1LL. In addition, the width, thickness, height, or area of the second sub-voltage wiring 2LL branched from the second node N2 may be formed to be smaller than those of the first sub-voltage wiring 1LL.

In addition, a portion of the second sub-voltage wiring 2LL included in the wiring pattern portion RGL branches from the second node N2, bends in a direction opposite to the first sub-voltage wiring 1LL, i.e., in the direction in which the power supply circuit 500 is arranged, and may be electrically connected to the third power input terminal T3 of the main driving circuit 400 by being bent in a shape including at least one of an angled-U shape, a reversed angled-U shape, and a Z shape.

As the second sub-voltage wiring 2LL includes a wiring pattern portion RGL in the shape obtained by combining and including at least one of an angled-U shape, a reversed angled-U shape, and a Z shape, the second sub-voltage wiring 2LL may maintain the resistance of a third wiring resistor R3 higher than that of the second wiring resistor R2 of the first sub-voltage wiring 1LL. Therefore, a DC driving voltage of the third level, which is lower than the DC driving voltage of the second level supplied to the second power input terminal T2 of the main driving circuit 400 through the first sub-voltage wiring 1LL, is supplied to the third power input terminal T3 of the main driving circuit 400 through the second sub-voltage wiring 2LL.

As described above, as the DC driving voltage of the main voltage wiring HL is distributed through the first sub-voltage wiring 1LL having a higher resistance, the voltage variation range of the DC driving voltage applied to the main voltage wiring HL may be narrowed to within the first level. In addition, as the DC driving voltages of the main voltage wiring HL and the first sub-voltage wiring 1LL are further distributed through the second sub-voltage wiring 2LL having a higher resistance, the voltage variation range of the DC driving voltages applied to the main voltage wiring HL and the first sub-voltage wiring 1LL may be narrowed to within the third level.

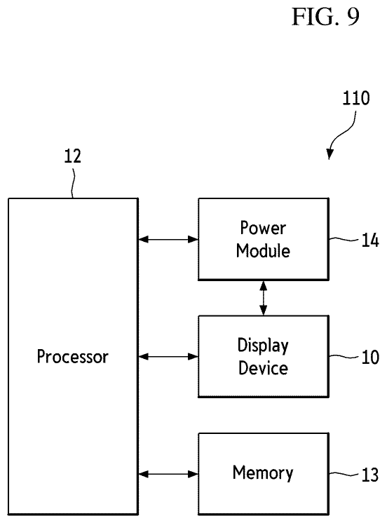

FIG. 9 is a block diagram of an electronic device including a display device, according to an embodiment of the present disclosure.

Referring to FIG. 9, an electronic device 110 according to an embodiment may include a display device 10, an image signal processor 12, a memory 13, and a power module 14.

The image signal processor 12 may include at least one of a central processing unit (CPU), an application processor (AP), a graphics processing unit (GPU), a communication processor (CP), an image signal processor (ISP), or a controller. As used herein, a processor may include more than one processor.

The memory 13 may store data and information required for the operation of the image signal processor 12 or the display device 10. When the image signal processor 12 executes an application stored in the memory 13, image data signals and/or input control signals may be delivered to the display device 10, and the display device 10 may process the received signals to output image information through a display screen.

The power module 14 may include a power supply module, such as a power adapter or a battery device, and a power conversion module that converts power supplied by the power supply module into power required for the operation of the electronic device 110.

At least one of the aforementioned components of the electronic device 110 may be included in a display device according to any one of the aforementioned embodiments. Additionally, some of individual modules included functionally within a single module may be included in the display device, and others may be provided separately from the display device. For example, the display device 10 may include a display panel, and the image signal processor 12, the memory 13, and the power module 14 may be provided as other devices included in the electronic device 110.

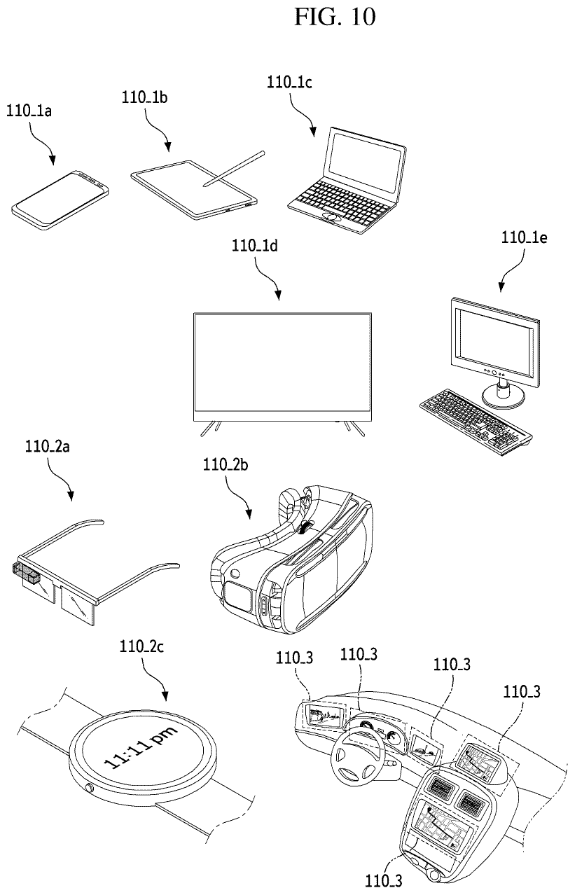

FIG. 10 illustrates schematic diagrams of electronic devices according to various embodiments.

Referring to FIG. 10, various electronic devices 110 to which the display device 10 is applicable may include image display electronic devices such as a smartphone 110_1a, a tablet PC 110_1b, a laptop 110_1c, a TV 110_1d, and a desktop monitor 110_1e, wearable electronic devices that include a display module, such as smart glasses 110_2a, a head-mounted display 110_2b, and a smart watch 110_2c, and vehicle electronic devices 110_3 that include a display module, such as a center information display (CID) arranged on the instrument panel, center fascia, or dashboard of a vehicle, and a room mirror display. The display device 10 may also be applicable to the display member of a TV, laptop computer, monitor, billboard, or Internet of Things (IoT) device.

In concluding the detailed description, those skilled in the art will appreciate that many variations and modifications can be made to the embodiments without substantially departing from the principles of the present disclosure. Therefore, the disclosed embodiments of the disclosure are used in a generic and descriptive sense only and not for purposes of limitation.

What is claimed is:

1. A display device comprising:
a display panel configured to display an image in an image display area;
a main driving circuit configured to control an image display operation of the display panel; and
a power supply circuit mounted on a circuit board and configured to supply a direct current (DC) driving voltage to the main driving circuit,
wherein the circuit board includes: a main voltage wiring configured to transmit a DC driving voltage of a first level, output from the power supply circuit, to a first power input terminal of the main driving circuit; and a first sub-voltage wiring branched from the main voltage wiring and configured to transmit a DC driving voltage of a second level, which is lower than the first level, to a second power input terminal of the main driving circuit.

2. The display device of claim 1, wherein the main voltage wiring includes a first wiring resistor having a first resistance and at least one first capacitor having a first capacitance, and is connected and arranged in a straight-line form with a shortest distance between a first driving voltage output terminal of the power supply circuit and the first power input terminal of the main driving circuit.

3. The display device of claim 2, wherein the first sub-voltage wiring branches from a first node of the main voltage wiring, formed at a position at a first distance closer to the power supply circuit than to the main driving circuit.

4. The display device of claim 3, wherein the first sub-voltage wiring includes a second wiring resistor having a second resistance higher than the first resistance of the first wiring resistor and at least one second capacitor having a second capacitance, and is connected and arranged to include at least one bend between the first node and the second power input terminal of the main driving circuit.

5. The display device of claim 4, wherein
the first sub-voltage wiring, branched from the first node of the main voltage wiring, is formed and arranged such that a length of the first sub-voltage wiring is greater than a length of the main voltage wiring, and
a width, thickness, height, or area of the first sub-voltage wiring is formed to be smaller than a width, thickness, height, or area of the main voltage wiring.

6. The display device of claim 3, wherein the first sub-voltage wiring includes a second wiring resistor having a second resistance higher than the first resistance of the first wiring resistor and at least one second capacitor having a second capacitance, and is connected and arranged to include a wiring pattern portion in which at least one bent pattern is formed between the first node and the second power input terminal of the main driving circuit.

7. The display device of claim 6, wherein the first sub-voltage wiring branches from the first node to be bent in a direction opposite to which the main voltage wiring extends from the power supply circuit, and is electrically connected to the second power input terminal of the main driving circuit by being bent at the wiring pattern portion in an angled-U shape or a reversed angled-U shape.

8. The display device of claim 6, wherein the first sub-voltage wiring branches from the first node to be bent in a direction opposite to which the main voltage wiring extends from the power supply circuit, and is electrically connected to the second power input terminal of the main driving circuit by being bent at the wiring pattern portion in a shape obtained by combining and including at least one of an angled-U shape, a reversed angled-U shape, and a Z shape.

9. The display device of claim 3, wherein the circuit board further includes a second sub-voltage wiring branched from a second node of the first sub-voltage wiring and configured to transmit a DC driving voltage of a third level, which is lower than the second level, to a third power input terminal of the main driving circuit.

10. The display device of claim 9, wherein the second sub-voltage wiring includes a third wiring resistor having a third resistance higher than a second resistance of the second wiring resistor and at least one third capacitor, further includes a wiring pattern portion in which at least one bent pattern is formed between the second node and the third power input terminal, branches from the second node to be bent in a direction opposite to the main voltage wiring and the first sub-voltage wiring, which is a direction in which the power supply circuit is arranged, and is electrically connected to the third power input terminal by being bent at the wiring pattern portion in a shape including at least one of an angled-U shape, a reversed angled-U shape, and a Z shape.

11. An electronic device comprising:
a display device configured to display an image;
an image signal processor configured to control an image display timing of the display device; and
a power supply module configured to provide a power signal to the display device,
wherein
the display device includes: a display panel configured to display an image in an image display area; a main driving circuit configured to control an image display operation of the display panel; and a power supply circuit mounted on a circuit board and configured to supply a direct current (DC) driving voltage to the main driving circuit, and
the circuit board includes: a main voltage wiring configured to transmit a DC driving voltage of a first level, output from the power supply circuit, to a first power input terminal of the main driving circuit; and a first sub-voltage wiring branched from the main voltage wiring and configured to transmit a DC driving voltage of a second level, which is lower than the first level, to a second power input terminal of the main driving circuit.

12. The electronic device of claim 11, wherein the main voltage wiring includes a first wiring resistor having a first resistance and at least one first capacitor having a first capacitance, and is connected and arranged in a straight-line form with a shortest distance between a first driving voltage output terminal of the power supply circuit and the first power input terminal of the main driving circuit.

13. The electronic device of claim 12, wherein the first sub-voltage wiring branches from a first node of the main voltage wiring, formed at a position at a first distance closer to the power supply circuit than to the main driving circuit.

14. The electronic device of claim 13, wherein the first sub-voltage wiring includes a second wiring resistor having a second resistance higher than the first resistance of the first wiring resistor and at least one second capacitor having a second capacitance, and is connected and arranged to include at least one bend between the first node and the second power input terminal of the main driving circuit.

15. The electronic device of claim 14, wherein
the first sub-voltage wiring, branched from the first node of the main voltage wiring, is formed and arranged such that a length of the first sub-voltage wiring is greater than a length of the main voltage wiring, and
a width, thickness, height, or area of the first sub-voltage wiring is formed to be smaller than a width, thickness, height, or area of the main voltage wiring.

16. The electronic device of claim 13, wherein the first sub-voltage wiring includes a second wiring resistor having a second resistance higher than the first resistance of the first wiring resistor and at least one second capacitor having a second capacitance, and is connected and arranged to include a wiring pattern portion in which at least one bent pattern is formed between the first node and the second power input terminal of the main driving circuit.

17. The electronic device of claim 16, wherein the first sub-voltage wiring branches from the first node to be bent in a direction opposite to which the main voltage wiring extends from the power supply circuit, and is electrically connected to the second power input terminal of the main driving circuit by being bent at the wiring pattern portion in an angled-U shape or a reversed angled-U shape.

18. The electronic device of claim 16, wherein the first sub-voltage wiring branches from the first node to be bent in a direction opposite to which the main voltage wiring extends from the power supply circuit, and is electrically connected to the second power input terminal of the main driving circuit by being bent at the wiring pattern portion in a shape including at least one of an angled-U shape, a reversed angled-U shape, and a Z shape.

19. The electronic device of claim 13, wherein the circuit board further includes a second sub-voltage wiring branched from a second node of the first sub-voltage wiring and configured to transmit a DC driving voltage of a third level, which is lower than the second level, to a third power input terminal of the main driving circuit.

20. The electronic device of claim 19, wherein the second sub-voltage wiring includes a third wiring resistor having a third resistance higher than a second resistance of the second wiring resistor and at least one third capacitor, further includes a wiring pattern portion in which at least one bent pattern is formed between the second node and the third power input terminal, branches from the second node to be bent in a direction opposite to the main voltage wiring and the first sub-voltage wiring, which is a direction in which the power supply circuit is arranged, and is electrically connected to the third power input terminal by being bent at the wiring pattern portion in a shape obtained by combining and including at least one of an angled-U shape, a reversed angled-U shape, and a Z shape.
